(19) United States
(12) Patent Application Publication
(10) Pub. No.: US 2026/0129504 A1
(43) Pub. Date: May 7, 2026

(54) METHOD AND APPARATUS FOR REPORTING DELAY STATUS OF MULTIPLE REMAINING TIME INTERVALS IN WIRELESS COMMUNICATION SYSTEM

(71) Applicant: Samsung Electronics Co., Ltd., Gyeonggi-do (KR)

(72) Inventors: Weiping SUN, Gyeonggi-do (KR); Hyunjeong KANG, Gyeonggi-do (KR)

(21) Appl. No.: 19/381,685

(22) Filed: Nov. 6, 2025

(30) Foreign Application Priority Data
Nov. 7, 2024 (KR) 10-2024-0157300

(51) Int. Cl. H04W 28/02

(52) U.S. Cl. CPC H04W 28/0236

(57) ABSTRACT

The disclosure relates to a 5G or 6G communication system to support a data transmission rate higher than before. Specifically, a method performed by a user equipment (UE) includes transmitting, to a base station, a first message including first information indicating that the UE supports a delay status report (DSR) using multiple reporting thresholds, receiving, from the base station, a second message configuring a remaining time threshold for triggering the DSR for a first logical channel group (LCG) and at least one reporting threshold for reporting the DSR for the first LCG, and transmitting, to the base station, a DSR medium access control (MAC) control element (CE) with multiple entries including the DSR for the first LCG.

### CROSS-REFERENCE TO RELATED APPLICATION(S)

This application is based on and claims priority under 35 U.S.C. § 119 to Korean Patent Application No. 10-2024-0157300, filed on Nov. 7, 2024, in the Korean Intellectual Property Office, the disclosure of which is incorporated herein by reference in its entirety.

### BACKGROUND

### 1. Field

The disclosure relates generally to a wireless communication system, and more particularly, to a method and apparatus for reporting a delay status of a remaining time interval in a wireless communication system.

### 2. Description of Related Art

5th generation (5G) mobile communication technologies define broad frequency bands such that high transmission rates and new services are possible, and can be implemented not only in sub 6 gigahertz (GHz) bands such as 3.5 GHz, but also in above 6 GHz bands referred to as millimeter wave (mm Wave) bands including 28 GHz and 39 GHz bands. In addition, it has been considered to implement 6G mobile communication technologies referred to as beyond 5G systems in terahertz (THz) bands (for example, 95 GHz to 3 THz bands) to achieve transmission rates fifty times faster than 5G mobile communication technologies and ultra-low latencies one-tenth of 5G mobile communication technologies.

Since the beginning of the development of 5G mobile communication technologies, to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access channel (2-step RACH) for simplifying random access procedures for NR. There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

With the development of communication systems, there is a need in the art for various demands for improving a delay status report (DSR) procedure to report a buffer size and a remaining time for a logical channel.

### SUMMARY

An aspect of the disclosure is to provide a method and apparatus for reporting a delay status of multiple remaining time intervals in a wireless communication system.

In accordance with an aspect of the disclosure, a method performed by a user equipment (UE) includes transmitting, to a base station, a first message including first information indicating that the UE supports a DSR using multiple reporting thresholds, receiving, from the base station, a second message configuring a remaining time threshold for triggering the DSR for a first logical channel group (LCG) and at least one reporting threshold for reporting the DSR for the first LCG, and transmitting, to the base station, a DSR medium access control (MAC) control element (CE) with multiple entries including the DSR for the first LCG.

In accordance with an aspect of the disclosure, a method performed by a base station includes receiving, from a user equipment (UE), a first message including first information indicating that the UE supports a DSR using multiple reporting thresholds, transmitting, to the UE, a second message configuring a remaining time threshold for triggering the DSR for first logical channel group (LCG) and at least one reporting threshold for reporting the DSR for the first LCG, and receiving, from the UE, a DSR medium access control (MAC) control element (CE) with multiple entries including the DSR for the first LCG.

In accordance with an aspect of the disclosure, a UE includes at least one transceiver, at least one processor communicatively coupled to the at least one transceiver, and at least one memory, communicatively coupled to the at least one processor, storing instructions executable by the at least one processor individually or in any combination to cause the UE to transmit, to a base station, a first message including first information indicating that the UE supports a DSR using multiple reporting thresholds, receive, from the base station, a second message configuring a remaining time threshold for triggering the DSR for a first logical channel group (LCG) and at least one reporting threshold for reporting the DSR for the first LCG, and transmit, to the base station, a DSR medium access control (MAC) control element (CE) with multiple entries including the DSR for the first LCG.

In accordance with an aspect of the disclosure, a base station includes at least one transceiver, at least one processor communicatively coupled to the at least one transceiver, and at least one memory, communicatively coupled to the at least one processor, storing instructions executable by the at least one processor individually or in any combination to cause the base station to receive, from a user equipment (UE), a first message including first information indicating that the UE supports a DSR using multiple reporting thresholds, transmit, to the UE, a second message configuring a remaining time threshold for triggering the DSR for a first logical channel group (LCG) and at least one reporting threshold for reporting the DSR for the first LCG, and receive, from the UE, a DSR medium access control (MAC) control element (CE) with multiple entries including the DSR for the first LCG.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure of a wireless communication system according to an embodiment;

FIG. 2 illustrates a radio protocol structure in a wireless communication system according to an embodiment;

FIG. 3 illustrates a procedure in which a UE establishes a connection with a network in a wireless communication system according to an embodiment;

FIG. 4 illustrates a DSR medium access control control element (MAC CE) format in a wireless communication system according to an embodiment;

FIG. 5 illustrates a method of reporting, by a UE, a delay status via an enhanced DSR in a wireless communication system according to an embodiment;

FIG. 6 illustrates an enhanced DSR MAC CE format in a wireless communication system according to an embodiment;

FIG. 7 illustrates a method of skipping a measurement gap occasion by a UE in a wireless communication system according to an embodiment;

FIG. 8 illustrates a UE device according to an embodiment; and

FIG. 9 illustrates a base station device according to an embodiment.

### DETAILED DESCRIPTION

Hereinafter, embodiments of the disclosure will be described in detail in conjunction with the accompanying drawings. In describing the disclosure below, a detailed description of known functions or configurations will be omitted for the sake of clarity and conciseness.

The terms which will be described below are terms defined in consideration of the functions in the disclosure, and may be different according to users, intentions of the users, or customs. Therefore, the definitions of the terms should be made based on the contents throughout the specification.

In the accompanying drawings, some elements may be exaggerated, omitted, or schematically illustrated. The size of each element does not completely reflect the actual size thereof. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure. Throughout the specification, the same or like reference signs indicate the same or like elements.

In the following description, a base station (BS) is an entity that allocates resources to terminals, and may be at least one of a Node B, an evolved Node B (eNB), a next generation Node B (gNB), a wireless access unit, a base station controller, and a node on a network. A terminal may include a UE, a mobile station (MS), a cellular phone, a smartphone, a computer, or a multimedia system capable of performing a communication function.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a user equipment (or UE) transmits data or control signals to a base station (or eNB or gNB), and the downlink refers to a radio link via which the base station transmits data or control signals to the UE. The above multiple access scheme separates data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

According to an embodiment, e MBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique may be required to be improved. Also, the data rate required for the 5G communication system may be obtained using a frequency bandwidth more than 20 MHz in a frequency band of 3 to 6 GHz or 6 GHz or above, instead of transmitting signals using a transmission bandwidth up to 20 MHz in a band of 2 GHz used in LTE.

In addition, mMTC is being considered to support application services such as the Internet of Things (IoT) in the 5G communication system. mMTC may have requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC, which is a cellular-based mission-critical wireless communication service, may be used for remote control for robots or machines, industrial automation, unmanned aerial vehicles, remote health care, emergency alert, and the like. Thus, URLLC must provide communication with low latency (ultra-low latency) and high reliability (ultra-high reliability). For example, a service supporting URLLC must satisfy an air interface latency of less than 0.5 ms, and may also require a packet error rate of 10-5 or less. Therefore, for the services supporting URLLC, a 5G system must provide a transmit time interval (TTI) shorter than those of other services, and also may require a design for assigning a large number of resources in a frequency band in order to secure reliability of a communication link.

The above-described three services considered in the 5G communication system, that is, eMBB, URLLC, and mMTC, may be multiplexed and transmitted in a single system. In this case, different transmission/reception techniques and transmission/reception parameters may be used between services in order to satisfy different requirements of the respective services. However, the above-described mMTC, URLLC, and eMBB are merely examples of different types of services, and service types to which the disclosure is applied are not limited to the above examples.

Embodiments of the disclosure as described below may also be applied to other communication systems having similar technical backgrounds or channel types to the embodiments of the disclosure, such as the 5th generation mobile communication technologies (5G, new radio, and NR) developed beyond LTE-A. 5G may be the concept that covers the exiting LTE, LTE-A, and other similar services. Based on determinations by those skilled in the art, the disclosure may also be applied to other communication systems through some modifications without significantly departing from the scope of the disclosure.

Herein, terms for identifying access nodes and referring to network entities or network functions, messages, interfaces between network entities, various identification information, and the like are illustratively used for the sake of descriptive convenience. Therefore, the disclosure is not limited by the terms as described below, and other terms referring to subjects having equivalent technical meanings may also be used.

In the following description, some of terms and names defined in the (3GPP LTE standards and/or 3GPP NR standards may be used for the sake of descriptive convenience. However, the disclosure is not limited by these terms and names, and may be applied in the same way to systems that conform other standards.

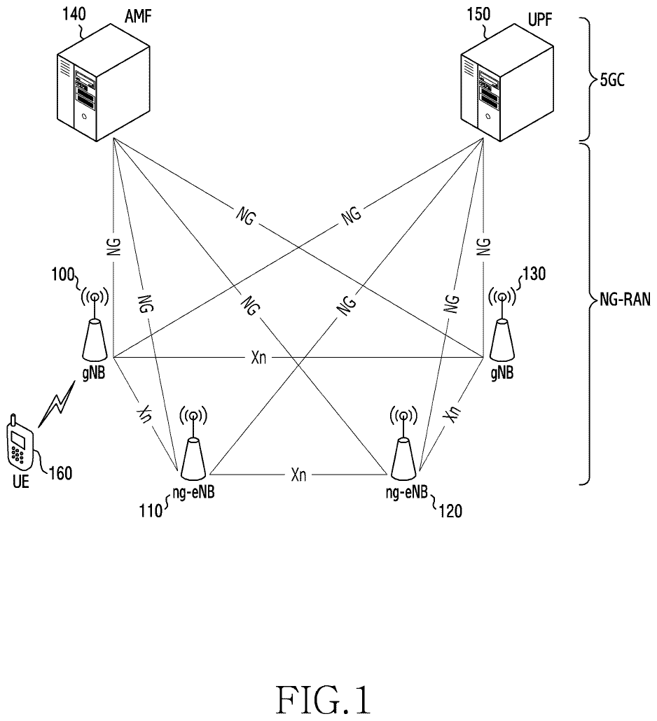

FIG. 1 illustrates a structure of a wireless communication NR system according to an embodiment.

Referring to FIG. 1, a wireless communication system may include multiple BSs (e.g., a gNB 100, an ng-eNB 110, an ng-eNB 120, or a gNB 130), an access and mobility management function (AMF) 140, and a user plane function (UPF) 150. The wireless communication system is not limited by the structure illustrated in FIG. 1, and may include a larger or smaller number of components than those of the structure in FIG. 1.

Herein, a UE 160 may access an external network via the BSs 100, 110, 120, and 130 and the UPF 150.

In FIG. 1, the BSs 100, 110, 120, or 130 may provide radio access to UEs that access the cellular network as network access nodes. For example, to service users' traffic, the BSs 100, 110, 120, or 130 may collect at least one piece of state information of the UEs, such as buffer states, available transmission power states, or channel states, and perform scheduling accordingly. The BSs may support connections between the UEs and the core network (CN). The CN of NR may refer to a 5th generation core network (5GC).

The gNBs 100 or 130 may control multiple cells. The gNBs 100 or 130 may employ an AMC scheme for determining a modulation scheme and a channel coding rate according to a channel state of the UE.

The core network may be a device responsible for various control functions, as well as a mobility management function for the UEs. The core network may be connected to multiple BSs The 5GC may interwork with the conventional LTE system.

A wireless communication system may be divided into a user plane (UP) associated with actual user data transfer and a control plane (CP) such as connection management. The gNB 100 and gNB 130 may use UP and CP techniques defined in the NR technology, The ng-eNB 110 and ng-eNB 120 may use UP and CP techniques defined in the LTE technology.

The AMF 140 may perform a mobility management function for the UE. The AMF 140 is responsible for various control functions and may be connected to multiple BSs.

The UPF 150 may refer to a gateway device for providing data transmission. The NR communication system may include a session management function (SMF). The SMF may manage a packet data network connection, such as a protocol data unit (PDU) session, provided to the UE.

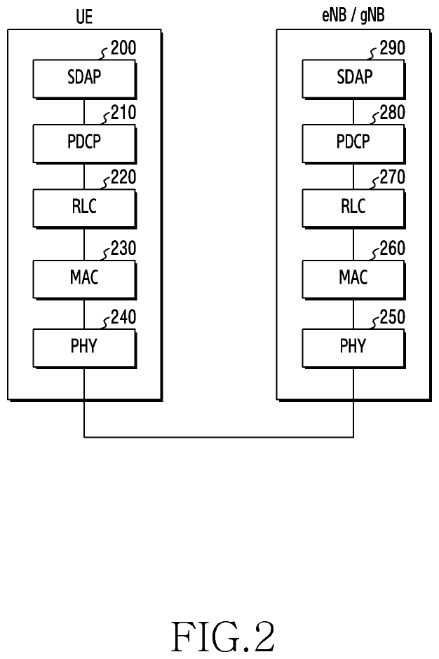

FIG. 2 illustrates a radio protocol structure in a wireless communication NR system according to an embodiment.

Referring to FIG. 2, a radio protocol of an NR system may include at least one of a service data adaptation protocol (SDAP) 200, a packet data convergence protocol (PDCP) 210, a radio link control (RLC) 220, a MAC 230, or a physical (PHY) 240 on a UE side. The descriptions below are merely examples, and the operations or functions of the SDAP, PDCP, RLC, PHY and MAC are not limited thereto.

The radio protocol of the NR system may include at least one of an SDAP 290, a PDCP 280, an MAC 260, or a PHY 250 on a BS side.

The SDAP, the PDCP, the RLC, the MAC, the PHY, and the RRC may be interchangeably used with and have the same meaning as the terms SDAP layer, PDCP layer, RLC layer, MAC layer, PHY layer, and RRC layer respectively.

The SDAP 200 or 290 layer may transfer user data. The SDAP 200 or 290 may perform at least one of an operation for mapping a quality of service (QoS) flow to a specific data radio bearer (DRB) for both UL and DL, operation for marking a QoS flow ID for both UL and DL, or an operation for mapping a reflective QoS flow to a data bearer for UL SDAP PDUs. An SDAP configuration corresponding to each DRB may be provided from a higher RRC layer.

The PDCP 210 or 280 may perform operations such as Internet protocol (IP) header compression and/or reconstruction. The PDCP 210 or 280 may provide at least one of an in-sequence and/or out-of-sequence delivery function, a reordering function, a duplicate detection function, a retransmission function, or a ciphering and deciphering function.

The RLC 220 or 270 may reconfigure a PDCP PDU into appropriate sizes. The RLC 220 or 270 may provide at least one of an in-sequence and/or out-of-sequence delivery function, an automatic repeat request (ARQ) function, a concatenation, segmentation, and reassembly function, a re-segmentation function, a reordering function, a duplicate detection function, or an error detection function.

The MAC 230 or 260 may be connected to several RLC layer devices configured in a single device. The MAC 230 or 260 may perform at least one of a method of multiplexing RLC PDUs into an MAC PDU or a method of demultiplexing RLC PDUs from an MAC PDU. The MAC may provide at least one of a mapping function, a scheduling information reporting function, a hybrid automatic repeat request (HARQ) function, a priority handling function between logical channels, a priority handling function between UEs, a multimedia broadcast and multicast service (MBMS) service identification function, a transport format selection function, or a padding function.

The PHY 240 or 250 may perform channel-coding and modulation of higher layer data to obtain OFDM symbols, and deliver the OFDM symbols through a radio channel. The PHY 240 or 250 may demodulate OFDM symbols received through a radio channel, perform channel-decoding thereof, and deliver the same to the higher layer. For additional error correction, the PHY layer may also use HARQ. A receiving node may use one bit to transmit whether a packet transmitted by a transmitting node is received. This 1-bit information may be HARQ ACK (acknowledgement)/NACK (negative acknowledgement) information.

In LTE, DL HARQ ACK or NACK information in response to UL data transmission may be transmitted via a physical hybrid-ARQ indicator channel (PHICH). In NR, whether retransmission is required or new transmission is to be performed may be determined through UE scheduling information via a physical dedicated control channel (PDCCH) that is a channel via which DL or UL resource allocation and the like are transmitted. This is because asynchronous HARQ may be applied in NR.

Uplink HARQ ACK or NACK information in response to DL data transmission may be transmitted via a physical UL control channel (PUCCH) or a physical UL shared channel (PUSCH). The PUCCH may be transmitted in an UL of a primary cell (PCell). If supported by a UE, the PUCCH may be transmitted in a secondary cell (SCell) as described below, which is referred to as a PUCCH SCell For example, if supported by a UE, the PUCCH may be transmitted from the UE to a BS in an UL of an SCell, which refer to a PUCCH SCell.

An RRC layer may exist as a higher layer than each PDCP layer of the UE and the BS. The RRC layer may transmit and/or receive access and/or measurement-related configuration control messages for radio resource control.

The PHY layer may include one or multiple frequencies or carriers. A technology for simultaneously configuring and using multiple frequencies may be referred to as carrier aggregation (CA). One carrier may be used for communication between a UE and a BS (eNB or gNB). In using the CA technology, a primary carrier and at least one secondary carrier may be used for communication between a UE and a BS. With regard to this, data transfer capacity may be increased with an increase in the number of secondary carriers. In LTE or NR, a cell in a BS, which uses the primary carriers, may be referred to a PCell, and a cell in a BS, which uses the secondary carrier, may be referred to as an SCell. An entity may be referred to as the term “layer device” and may be used as the same meaning as the term.

A UE may report a remaining time status of buffered data and a data size. A BS that receives the report may preferentially service urgent data with a short remaining time for the UE. In addition, when multiple UEs exist, the BS may preferentially provide a service to a UE that stores the most urgent data in a buffer.

Herein, when a UE reports a remaining time status of data stored in a buffer, a method of reporting a size of corresponding data for each remaining time interval and a remaining time of data that has the shortest remaining time in a corresponding interval, based on one or multiple remaining time threshold values configured by the BS. Based on data remaining time and size information for multiple remaining time intervals, the BS may perform efficient UL scheduling that reduces data loss caused by expiration of a remaining time.

Although a DSR capable of reporting a buffer size and a minimum remaining time for one or more remaining time intervals for each logical channel group (LCG) is referred to as an enhanced DSR in the disclosure, the name of the DSR in the disclosure is not limited. For example, the DSR may be referred to as another name in addition to the enhanced DSR, such as an extended DSR, refined DSR, multi-pair DSR, or others.

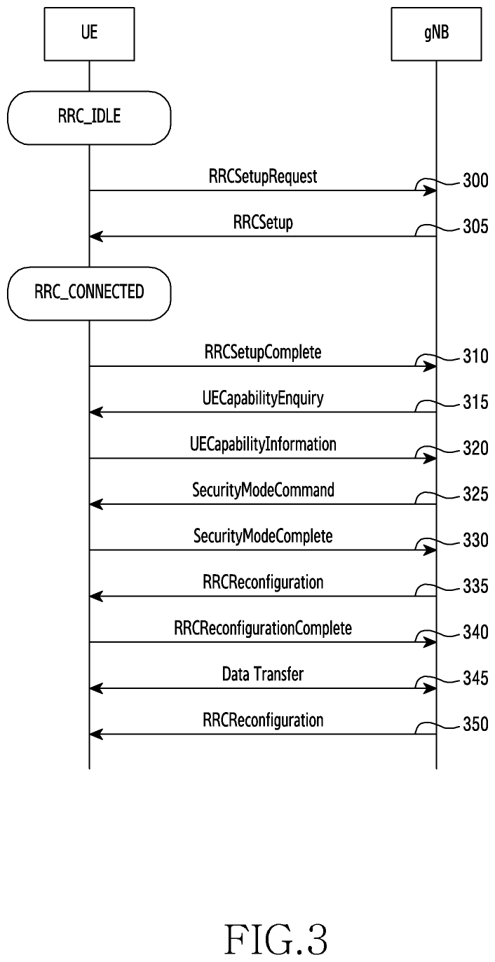

FIG. 3 illustrates a procedure in which a UE establishes an RRC connection with a BS in a wireless communication system according to an embodiment.

Referring to FIG. 3, the UE switches from an RRC idle mode (RRC_IDLE) to an RRC connected mode (RRC_CONNECTED) so as to establish a connection with a network. The UE may establish UL or DL transmission synchronization with the BS via a random access process.

The UE may transmit an RRCSetupRequest message to the BS in step 300. In the RRCSetupRequest message, at least one of the UE's identifier or a cause (EstablishmentCause) of establishing a connection may be included.

The BS may transmit an RRCSetup message to the UE so that the UE is capable of establishing an RRC connection in step 305. For example, in the RRCSetup message, MAC layer device configuration information (e.g., MAC-CellGroupConfig) belonging to a corresponding cell group may be included for each cell group (e.g., at least one of a master cell group (MCG) or secondary cell group (SCG)). For example, in the RRCSetup message, configuration information (e.g., ServingCellConfig) of a serving cell (serving cell, special cell (SpCell), or SCell) belonging to a corresponding cell group may be included for each cell group (e.g., serving cell, special cell (SpCell), or SCell).

The UE that establishes the RRC connection may enter the RRC_CONNECTED mode. The UE may transmit an RRCSetupComplete message to the BS in step 310.

When the BS is not aware of the capability of the UE with which the current connection is established, or when the BS needs to recognize the UE capability, the BS may transmit, to the UE, a message (e.g., UECapabilityEnquiry) for enquiring about the UE capability in step 315. The BS may include a radio access technology (RAT) type-based UE capability request in the UECapabilityEnquiry message 315. When requesting the UE to generate a UECapabilityInformation message 320 via the UE capability request message 315, the BS may include filtering information that indicates a condition and a limitation. The filtering information may include frequency band list information that requests an RAT type-based capability report. The filtering information may indicate whether an RAT type-based UE needs to report whether it supports a predetermined function. The filtering information may indicate whether the UE needs to report whether it supports an enhanced DSR disclosed herein for a predetermined RAT type (e.g., NR).

The UE may transmit a message that reports the UE's capability (e.g., UECapabilityInformation) to the BS in step 320. The UE capability reporting message may include an indicator indicating whether the UE supports a DSR report in association with data in a buffer. When a DSR support field (e.g., delayStatusReport-r18) in the message is configured to supported, the BS may determine, identify, or regard that the UE supports a DSR report in association with the data in the buffer. When the DSR supported field does not exist, the BS may determine, identify, or regard that the UE does not support a DSR report in association with the data in the buffer. Based on the message reporting the UE capability, received from the UE, the BS may be aware of whether the UE supports a DSR. When the UE supports a DSR, the BS may transmit or transfer DSR configuration information to the UE for each cell group via an RRC message (e.g., RRCReconfiguration message (at least one of a message 335 or a message 350).

The UE capability report message may include an indicator indicating whether the UE supports an enhanced DSR (e.g., function of reporting a delay status for multiple remaining time intervals for each LCG). When a predetermined field (e.g., enhancedDelayStatusReport) in the message is configured to supported, the BS may regard that the UE supports an enhanced DSR. When the field does not exist, the BS may regard that the UE does not support an enhanced DSR. The field may be expressed as 1-bit information (e.g., 1: supported, 0: not supported). Based on the message reporting the UE capability, received from the UE, the BS may be aware of whether the UE supports an enhanced DSR. When the UE supports the enhanced DSR, the BS may transmit or transfer enhanced DSR configuration information to the UE for each MAC layer device/cell group via an RRC message (e.g., RRCReconfiguration message (at least one of the message 335 or the message 350).

The BS may transmit a SecurityModeCommand message to the UE to establish security with the UE in step 325. In response thereto, the UE may transmit a SecurityModeComplete message to the BS in step 330.

The BS may include a cell group-based MAC layer device configuration (e.g., MAC-CellGroupConfig IE) in the RRCReconfiguration message 335, so as to perform configuration in association with a MAC layer device of a predetermined cell group of the UE.

The cell group-based MAC layer device configuration information (e.g., MAC-CellGroupConfig) may include at least one of the following enhanced DSR related configuration information.

One remaining time threshold value (e.g., remainingTimeThreshold-r18) may be configured for each LCG or LCG ID. The remaining time threshold value may be a remaining time threshold value related to a method of triggering an enhanced DSR/DSR in a logical channel (LCH) belonging to a corresponding LCG. The remaining time threshold value may be referred to as a trigger threshold value (triggering threshold) of the corresponding LCG/LCH. The trigger threshold value of the LCG/LCH may be referred to as a remaining time threshold value (remainingTimeThreshold-r18) included in an LCG-based (i.e., legacy) DSR configuration (e.g., LCG-DSR-Config-r18).

For each LCG (or LCG ID), one or multiple additional remaining time threshold values (e.g., remainingTimeThresholdN-r19, N=1, 2, 3 . . . . M) may be configured, in addition to the trigger threshold value. The additional remaining time threshold value may be related to an enhanced DSR report operation. The additional remaining time threshold value may be referred to as a reporting threshold value (triggering threshold) of a corresponding LCG/LCH which may be configured for an LCG for which a trigger threshold value is configured.

Each of the trigger and/or reporting threshold value may be configured in an integer form. The trigger and/or reporting threshold value may be configured in an integer form indicating a predetermined time unit (e.g., second/millisecond/microsecond/frame/subframe/slot/symbol).

When RRC (re) configuration is completed, the UE may transmit RRCReconfigurationComplete message to the BS in step 340.

The UE and the BS may perform a data transmission procedure in step 345. In this instance, a general data transmission process may include three steps including RRC connection establishment, security establishment, and DRB configuration.

The BS may transmit an RRCReconfiguration message to newly configure, add, or change a configuration in step 350.

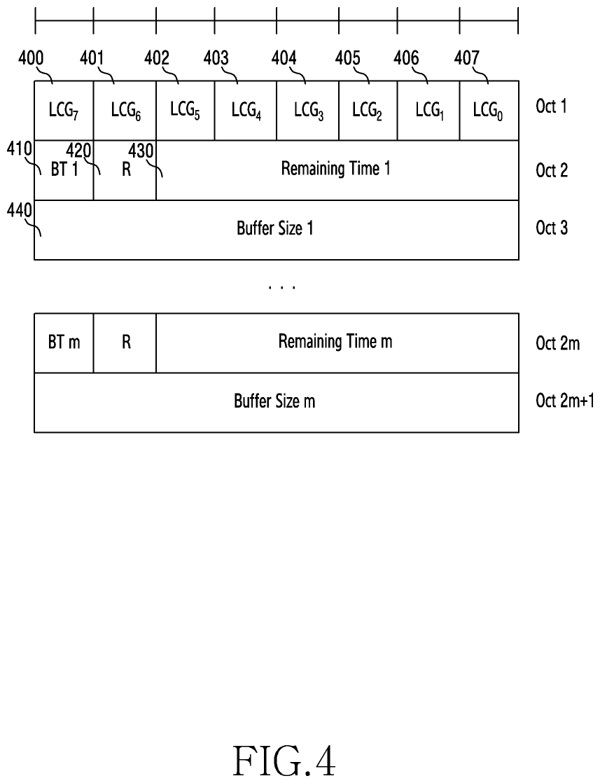

FIG. 4 illustrates a DSR MAC CE format according to an embodiment.

Referring to FIG. 4, the UE transmits a DSR MAC CE to a BS, so as to report, to the BS, a size of delay critical UL data in a buffer and a minimum remaining time for each LCG. The DSR MAC CE may include the following fields, but is not limited to the following example.

LCGi 400, 401, 402, 403, 404, 405, 406, 407: The corresponding field may indicate that delay information (e.g., remaining time and buffer size fields) for LCGi exists (or is included) in the DSR MAC CE. The LCGi field configured to 1 may indicate that delay information for LCGi is reported. The LCGi field configured to 0 indicates that delay information for LCGi is not reported.

Remaining time 1 (RM) 430: The corresponding field may exist for each LCG. The corresponding field may indicate a PDCP discardTimer remaining time (value) of a PDCP service data unit (SDU) having the shortest remaining time (value) of a running PDCP discardTimer among PDCP SDUs that are buffered in a corresponding LCG and are never transmitted via a MAC PDU, based on a first symbol transmission time of initial transmission (first PUSCH transmission) of a PUSCH including the DSR MAC CE. A length of the corresponding field may be 6 bits. The corresponding field may exist only when a buffer size indicated by a corresponding buffer size field is not 0. Otherwise, the corresponding field may be configured to 0 as a reserved field. When the corresponding field exists and a field value is configured to r, this indicates that a range of a remaining time is (r, r+1] millisecond (msec) (e.g., greater than r msec and less than or equal to r+1 msec).

BT 410: The corresponding field may exist for each LCG. The corresponding field may exist only when a corresponding LCG is configured with additionalBSR-TableAllowed and a buffer size indicated by a corresponding buffer size field is not 0. Otherwise, the corresponding field may be configured to 0 as a reserved field. When the corresponding field exists, a field value of 1 may indicate that a corresponding buffer size field value is configured using a first table, such as in the relevant standard. A field value of 0 may indicate that configuration is performed using a second table, such as in the relevant standard.

Buffer size 1 (BS) 440: The corresponding field may indicate a total delay-critical UL data size of associated RLC and PDCP layer devices determined according to RLC and PDCP layer devices' data size calculating method defined in the relevant standard, after a corresponding MAC PDU is made. When a corresponding LCG is configured with additionalBS-TableAllowed, and the amount of delay-critical UL data of the corresponding LCG falls within a buffer size range specified in the first table in the relevant standard, a corresponding MAC layer device of the UE may configure a buffer size field using the first table. Otherwise, the corresponding MAC layer device may use the second table in the relevant standard. The corresponding field may be indicated based on a byte unit, and a length of the field may be 8 bits.

The DSR MAC CE of FIG. 4 may include delay information of every LCG having a pending DSR when a MAC PDU including the DSR MAC CE is built or to be built.

Referring to FIG. 4, a remaining time field, a BT field, and a buffer size field of a predetermined LCG may be reported using two consecutive octets. The three fields for different LCGs may be included in the DSR MAC CE in ascending order of LCGi.

FIG. 4 is merely an example of a DSR MAC CE structure, and the structure of the DSR MAC CE is not necessarily limited to the structure of FIG. 4 but may be configured in various forms including the fields of the DSR MAC CE described with reference to FIG. 4. The configuration of the above-described DSR MAC CE may be applied to various embodiments of the disclosure that use a DSR MAC CE.

A DSR that the UE reports to the BS may report, for each LCG, the shortest remaining discardTimer value among PDCP SDUs buffered in each LCG. However, data reported via a buffer size field may have different discardTimer values, as opposed to the same remaining discardTimer value. Therefore, when the BS allocates, to a predetermined UE, an UL resource based on the shortest remaining discardTimer value based on a DSR reported by the UE, the BS may fail to secure an UL resource for more urgent data of another UE.

Disclosed is a method of reporting multiple remaining times and/or buffer sizes via an enhanced DSR based on multiple reporting threshold values for each LCG configured by the BS, in addition to the shortest remaining discardTimer value. Through the above, the BS may receive a report of the overall buffer remaining time status from the UE, and may provide an optimized UL resource allocation scheme based on a detailed remaining time status.

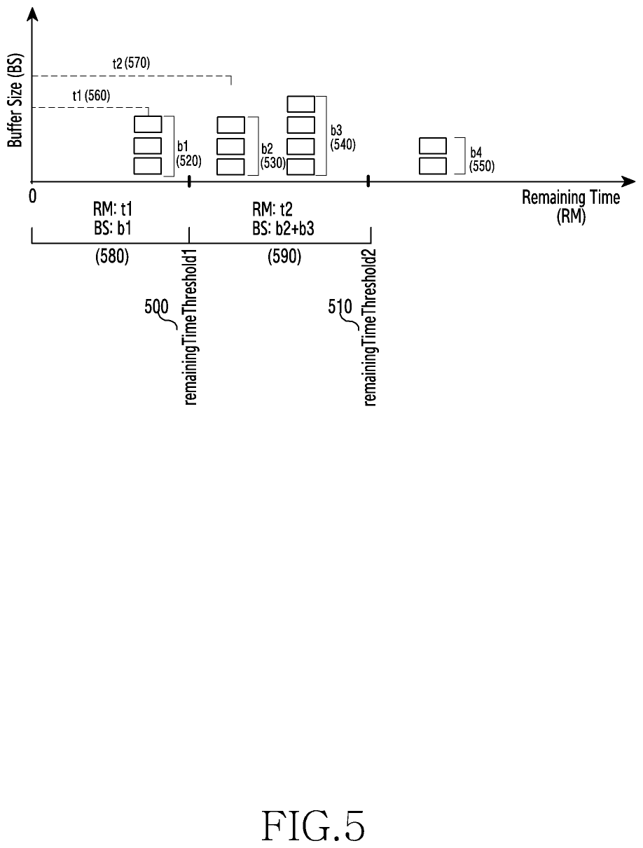

FIG. 5 illustrates a method of reporting a delay status of data in a buffer via an enhanced DSR by a UE in a wireless communication system according to an embodiment.

Referring to FIG. 5, an embodiment is provided in which, when a BS configures one trigger threshold value and one or more reporting threshold values for a predetermined LCG of a UE, the UE applies the multiple threshold values to the corresponding LCG and reports a delay status. and The BS configures remainingTimeThreshold1 500 remainingTimeThreshold2 510 (e.g., remaining TimeThreshold1<remainingTimeThreshold2) for the corresponding LCG. For example, remainingTimeThreshold1 500 may be a trigger threshold value or a reporting threshold value. For example, remaining TimeThreshold2 510 may be a trigger threshold value or a reporting threshold value.

The UE may report a data delay status of the corresponding LCG via an enhanced DSR. The UE may report, to the BS, a buffer delay status via an enhanced DSR according to the following embodiment.

The enhanced DSR may include multiple remaining time fields for each LCG. The multiple remaining time fields may be remaining time fields respectively corresponding to remaining time intervals between multiple remaining time threshold values (e.g., trigger threshold values and/or reporting threshold values) that the BS configures for the corresponding LCG. An upper limit and a lower limit of each remaining time interval may be configured by two consecutive remaining time threshold values (trigger threshold value or reporting threshold value). Among the remaining time intervals, a remaining time interval configured with the lowest remaining time threshold value (trigger threshold value or reporting threshold value) as an upper limit (e.g., lower limit is configured to 0) may be included. A remaining time field for a predetermined remaining time interval of the predetermined LCG may indicate the lowest remaining time among the remaining times (e.g., remaining discardTimer values) of PDCP SDUs buffered in the corresponding LCG and belonging to the corresponding remaining time interval. T1 560 is the lowest remaining time that belongs to a remaining time interval [0, remainingTimeThreshold1] among remaining times of the PDCP SDUs buffered in the corresponding LCG, and thus t1 560 may be reported via a remaining time field for the corresponding remaining time interval of the LCG.

The enhanced DSR may include one or more buffer size fields for each LCG. Each of the one or more buffer size fields of a predetermined LCG may report a data size/buffer size of data with a remaining time belonging to a corresponding remaining time interval among data buffered in the corresponding LCG, with respect to remaining time intervals between remaining time threshold values (trigger threshold values and/or reporting threshold values) that the BS configures for the corresponding LCG. Among the remaining time intervals, a remaining time interval configured with the lowest remaining time threshold value (trigger threshold value or reporting threshold value) as an upper limit (e.g., lower limit is configured to 0) may be included.

In FIG. 5, via a buffer size field corresponding to the remaining time interval of which the upper limit is remaining TimeThreshold1 500 (trigger threshold value or reporting threshold value) of the corresponding LCG, the UE may report an entire data size b1 520 of data with a remaining time less than or less than or equal to remainingTimeThreshold1 500 among data of the corresponding LCG. In addition, the UE may report, via the corresponding buffer size field, a data size/buffer size b2 530+b3 540 of data with a remaining time belonging to a remaining time interval [remainingTimeThreshold1 500, remainingTimeThreshold2 510] of the corresponding LCG.

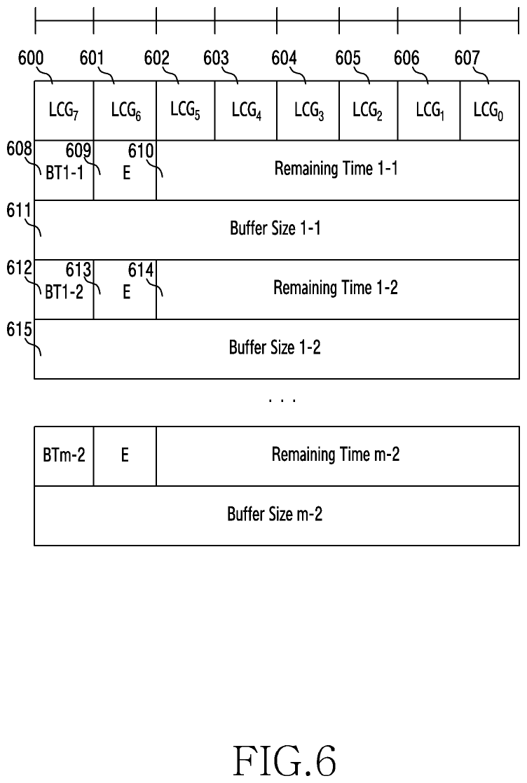

FIG. 6 illustrates an enhanced DSR MAC CE format in a wireless communication system according to an embodiment.

Referring to FIG. 6, the UE may configure a logical channel identifier (LCID)/extended LCID (eLCID) field of a MAC subheader to a predetermined value indicating an enhanced DSR MAC CE, and may indicate a corresponding MAC CE as an enhanced DSR MAC CE. In addition, the BS may identify that the corresponding MAC CE is an enhanced DSR MAC CE via the LCID/eLCID field.

The enhanced DSR MAC CE may include at least one of the following fields but is not limited to the example.

LCGi 600, 601, 602, 603, 604, 605, 606, 607: The corresponding field may indicate that delay information (e.g., remaining time and buffer size fields) for LCGi exists (or is included) (at least a pair). The LCGi field configured to 1 may indicate that delay information for LCGi exists/is reported. The LCGi field configured to 0 may indicate that delay information for LCGi does not exist/is not reported. For example, using 8 bits in a first byte of the enhanced DSR MAC CE, each LCGi from LCG7 to LCG0 may be indicated. For example, from a second byte of the enhanced DSR MAC CE, one or more pairs of a remaining time field and a buffer size field may be added for each LCG with respect to LCGs of which the LCGi bit is configured to 1. One or more combinations of [one or more fields among a remaining time field, a BT field, an extension field, and a buffer size field] of a predetermined LCG may be reported via consecutive octets. The field sets/pairs for different LCGs may be included in the enhanced DSR MAC CE in ascending or descending order of LCGi. For example, one or more combinations of [one or more fields among a remaining time field, a BT field, an extension field, and a buffer size field] of a predetermined LCG may be included in ascending or descending order of remaining time field values, corresponding remaining time threshold values, or remaining time intervals.

Remaining time 610, 614: A remaining time field may exist for each remaining time threshold value/interval configured for a corresponding LCG. The corresponding field may indicate a discardTimer remaining time/value of a PDCP SDU with the shortest remaining discardTimer value that is running and belonging to a corresponding remaining time interval, among PDCP SDUs that are buffered in the corresponding LCG and are never transmitted via a MAC PDU, based on a first symbol transmission time of initial transmission (first PUSCH transmission) of a PUSCH including the enhanced DSR MAC CE. A length of the remaining time field may be 6 bits. The remaining time field may exist only when a buffer size indicated by a buffer size field in the corresponding remaining time interval is not 0/is greater than 0. Otherwise, the corresponding remaining time field may be configured to 0 as a reserved field. When a remaining time field value is configured to r, this may indicate that a remaining time is a time range (r, r+1] (e.g., greater than r and less than or equal to r+1) having a predetermined time unit (e.g., msec or microsecond). A remaining time indicated by a remaining time field may be configured based on an added remaining time relative to a remaining time indicated by an immediately previous remaining time field or a first remaining time field belonging to the same LCG (or a difference value therebetween). When only one remaining time threshold value (e.g., trigger threshold value or reporting threshold value) is configured for a predetermined LCG, when a reporting threshold value is not configured, when only a trigger threshold value (e.g., remainingTimeThreshold) is configured, or when an enhanced DSR related configuration is not configured, a maximum of one remaining time field of the corresponding LCG may be included. In this instance, the remaining time field may indicate a PDCP discardTimer remaining time (value) of a PDCP SDU having the shortest remaining time (value) of a running PDCP discardTimer among PDCP SDUs that are buffered in the corresponding LCG and are never transmitted via a MAC PDU, based on a first symbol transmission time of initial transmission (first PUSCH transmission) of a PUSCH including the enhanced DSR MAC CE. For example, only when the remaining time (value) is less than a trigger threshold value (e.g., remainingTimeThreshold) of the corresponding LCG, reporting may be performed via the remaining time filed of the corresponding LCG. When multiple remaining time threshold values/intervals are configured for a predetermined LCG, multiple remaining time fields may exist.

BT(1-bit) 608, 612: The corresponding field may exist for each remaining time interval configured for a corresponding LCG. The corresponding field may exist only when the corresponding LCG is configured with additionalBSR-TableAllowed and a buffer size indicated by a corresponding buffer size field is not 0. Otherwise, the corresponding field may be configured to 0 as a reserved field. When the corresponding field exists, a field value of 1 may indicate that a corresponding buffer size field value is configured using a first table (e.g., Table 6.1.3.1-3 of TS 38.321). A field value of 0 may indicate that configuration is performed using a second table (e.g., Table 6.1.3.1-2 of TS 38.321). When multiple remaining time threshold values/intervals are configured for the corresponding LCG, multiple BT fields may exist.

Buffer size (BS) 611, 615: The corresponding field may indicate a UL data size calculated based on a corresponding remaining time interval among associated RLC and PDCP layer devices' data determined according to RLC and PDCP layer devices' data size calculating method defined in the relevant standard, after a corresponding MAC PDU is made. When the corresponding LCG is configured with additionalBS-TableAllowed and a buffer size indicated by the corresponding buffer size field falls within a buffer size range specified in the first table (e.g., Table 6.1.3.1-3 of TS 38.321), a corresponding MAC layer device of the UE may configure the corresponding buffer size field using the first table (Table 6.1.3.1-3 of TS 38.321). Otherwise, the corresponding MAC layer device may use the second table (e.g., table 6.1.3.1-2 of TS 38.321). The buffer size may be indicated based on a byte unit, and a length of the buffer field may be 8 bits. When only one remaining time threshold value (e.g., trigger threshold value or reporting threshold value) is configured for the corresponding LCG, when a reporting threshold value is not configured, when only a trigger threshold value is configured, or when an enhanced DSR related configuration is not configured, the corresponding field may indicate a total delay-critical UL data size of associated RLC and PDCP layer devices determined according to RLC and PDCP layer devices' data size calculating method defined in clause 5.5 (RLC) of TS 38.322 and clause 5.15 (PDCP) of TS 38.323, after the corresponding MAC PDU is made. When multiple remaining time threshold values/intervals are configured for the corresponding LCG, multiple buffer size fields may exist.

Extension (E) 609, 613: The corresponding field may indicate whether an additional (or further) combination (all or some fields) of [one or more fields among a BT field, an extension field, a remaining time field, and a buffer size field] belonging to the same LCG exists (or is included)/follows. When the corresponding field is configured to 1, this indicates that an additional combination of [one or more fields among a BT field, an extension field, a remaining time field, and a buffer size field] belonging to the same LCG exists (or is included)/follows. When the corresponding field is configured to 0, this may indicate that an additional combination of [one or more fields among a BT field, an extension field, a remaining time field, and a buffer size field] belonging to the same LCG does not exist (or is not included)/does not follow. The corresponding field may indicate whether a subsequent combination of [one or more fields among a BT field, an extension field, a remaining time field, and a buffer size field] belongs to the same LCG (e.g., 1 indicates belonging to the same LCG and 0 indicates belonging to a different LCG, or 1 indicates belonging to a different LCG and 0 indicates belonging to the same LCG). When only one remaining time threshold value (e.g., trigger threshold value or reporting threshold value) is configured for the corresponding LCG, when a reporting threshold value is not configured, when only a trigger threshold value is configured, or when an enhanced DSR related configuration is not configured, the corresponding field may configured to 0 as a reserved field.

To distinguish two DSR MAC CE formats, a DSR MAC CE (e.g., FIG. 4) capable of reporting at most one remaining time/buffer size for each LCG is referred to as a first DSR MAC CE or legacy DSR MAC CE, and a MAC CE (e.g., FIG. 6) capable of reporting two or more remaining times/buffer sizes is referred to as a second DSR MAC CE or enhanced DSR MAC CE.

The enhanced DSR MAC CE may include delay information of every LCG having a pending DSR when a MAC PDU including the corresponding enhanced DSR MAC CE is built or to be built.

The enhanced DSR MAC CE may include delay information of every LCG that has delay information (e.g., buffer size and/or remaining time) to report (in association with at least one remaining time threshold value (reporting threshold value and/or trigger threshold value)/interval) when a MAC PDU including the corresponding enhanced DSR MAC CE is built or to be built. When delay information to be reported exists, this may indicate that UL data (e.g., PDCP/RLC PDU/SDU) of which a remaining time of a running PDCP discardTimer is less than the largest threshold value (e.g., largest value between a reporting threshold value and trigger threshold value) of the corresponding LCG or the largest reporting threshold value or trigger threshold value, and that are never transmitted via a MAC PDU yet, exists in the corresponding LCG.

With respect to an LCG configured with delay status reporting (e.g., LCG-DSR-Config-r18 or LCG-DSR-Config-r19 or DSR/Enhanced DSR related configuration), a MAC layer delay may perform the following operations with respect to each LCH belonging to the corresponding LCG.

When the lowest (shortest) remaining time/value of a running PDCP discardTimer among PDCP SDUs that are never transmitted via a MAC PDU yet and of which data sizes are never reported via a legacy DSR MAC CE or enhanced DSR MAC CE among PDCP SDUs buffered in the corresponding LCH, decreases to less than a corresponding LCG remaining time threshold value (e.g., this may indicate remainingTimeThreshold or trigger threshold value);

When no DSR that is pending in the corresponding LCH exists:

DSR may be triggered for the corresponding LCH.

This may be not to trigger a new DSR since the BS is aware of the existence and remaining time of data when the data has already been reported via a legacy DSR MAC CE or enhanced DSR MAC CE.

When at least one DSR is pending, a MAC layer device may operate as follows.

When an UL shared channel (UL-SCH) resource for new transmission is available, and the corresponding UL-SCH resource is capable of accommodating a legacy DSR MAC CE or enhanced DSR MAC CE and a corresponding subheader, as a result of LCP:

This may indicate a multiplexing and assembly process so as to generate a legacy DSR MAC CE or enhanced DSR MAC CE. A MAC CE to be generated, either the legacy DSR MAC CE or enhanced DSR MAC CE, may be determined according to a UE's implementation or a predetermined indicator configured by a BS.

Otherwise, according to a DSR process, when a pending SR has yet to be triggered for a corresponding LCH of the corresponding DSR:

This may trigger a scheduling request (SR).

When a DSR is pending in an LCG, this may indicate that a DSR that is triggered and is not yet cancelled is pending/exists in an (at least one) LCH belonging to the corresponding LCG.

When at least one DSR is pending, a MAC layer device may operate as follows.

When at least one LCG among LCGs with a pending DSR or delay information to report is configured with two or more (i.e., multiple) remaining time threshold values (e.g., one or more reporting threshold values and one trigger threshold value):

When an UL-SCH resource for new transmission is available, and the corresponding UL-SCH resource is capable of accommodating an enhanced DSR MAC CE and a corresponding subheader, as a result of LCP:

This may indicate a multiplexing and assembly process, so as to generate an enhanced DSR MAC CE.

When an UL-SCH resource for new transmission is available, and the corresponding UL-SCH resource is incapable of accommodating an enhanced DSR MAC CE and a corresponding subheader, as a result of LCP:

When, according to a DSR process, a pending SR has yet to be triggered for a corresponding LCH of the corresponding DSR:

This may trigger an SR.

When an UL-SCH resource for new transmission is available, and the corresponding UL-SCH resource is capable of accommodating a legacy DSR MAC CE and a corresponding subheader but is incapable of accommodating an enhanced DSR MAC CE and a corresponding subheader, as a result of LCP:

This may indicate a multiplexing and assembly process, so as to generate a legacy DSR MAC CE. As another example, when the BS performs configuration using an indicator so that, in this instance, it generates a legacy DSR MAC CE, the this may indicate a multiplexing and assembly process and generate a legacy DSR MAC CE.

When an UL-SCH resource for new transmission is available, and the corresponding UL-SCH resource is incapable of accommodating a legacy DSR MAC CE and a corresponding subheader, as a result of LCP:

When, according to a DSR process, a pending SR has yet to be triggered for a corresponding LCH of the corresponding DSR:

This may trigger an SR.

Otherwise:

When an UL-SCH resource for new transmission is available, and the corresponding UL-SCH resource is capable of accommodating a legacy DSR MAC CE and a corresponding subheader, as a result of LCP:

This may indicate a multiplexing and assembly process, so as to generate a legacy DSR MAC CE.

Otherwise, according to a DSR process, when a pending SR has yet to be triggered for a corresponding LCH of the corresponding DSR:

This may trigger an SR.

When at least one DSR is pending, a MAC layer device may operate as follows.

When at least one LCG among LCGs with a pending DSR or delay information to report is configured with multiple remaining time threshold values (e.g., one or more reporting threshold values and one trigger threshold value), and a delay status (e.g., remaining time, buffer size) for two or more remaining time threshold values/intervals needs to be reported:

When an UL-SCH resource for new transmission is available, and the corresponding UL-SCH resource is capable of accommodating an enhanced DSR MAC CE and a corresponding subheader, as a result of LCP:

This may indicate a multiplexing and assembly process, so as to generate an enhanced DSR MAC CE.

When an UL-SCH resource for new transmission is available, and the corresponding UL-SCH resource is incapable of accommodating an enhanced DSR MAC CE and a corresponding subheader, as a result of LCP:

When, according to a DSR process, a pending SR has yet to be triggered for a corresponding LCH of the corresponding DSR:

This may trigger an SR.

When an UL-SCH resource for new transmission is available, and the corresponding UL-SCH resource is capable of accommodating a legacy DSR MAC CE and a corresponding subheader but is incapable of accommodating an enhanced DSR MAC CE and a corresponding subheader, as a result of LCP:

This may indicate a multiplexing and assembly process, so as to generate a legacy DSR MAC CE. As another example, when the BS performs configuration using an indicator so that, in this instance, it generates a legacy DSR MAC CE, this may indicate a multiplexing and assembly process and generate a legacy DSR MAC CE.

When an UL-SCH resource for new transmission is available, and the corresponding

UL-SCH resource is incapable of accommodating a legacy DSR MAC CE and a corresponding subheader, as a result of LCP:

When, according to a DSR process, a pending SR has yet to be triggered for a corresponding LCH of the corresponding DSR:

This may trigger an SR.

Otherwise:

When an UL-SCH resource for new transmission is available, and the corresponding UL-SCH resource is capable of accommodating a legacy DSR MAC CE and a corresponding subheader, as a result of LCP:

This may indicate a multiplexing and assembly process, so as to generate a legacy DSR MAC CE.

Otherwise, according to a DSR process, when a pending SR has yet to be triggered for a corresponding LCH of the corresponding DSR:

This may trigger an SR.

When at least one DSR is pending, a MAC layer device may operate as follows.

When at least one LCG among LCGs with a pending DSR or delay information to report is configured with two or more (multiple) remaining time threshold values (e.g., one or more reporting threshold values and one trigger threshold value), and a delay status/information (e.g., remaining time, buffer size) for two or more remaining time threshold values/intervals needs to be reported:

Via an enhanced DSR MAC CE, the delay status/information of every LCG having a pending DSR or delay information to report may be reported.

Otherwise:

Via a legacy DSR MAC CE, the delay status/information of every LCG having a pending DSR may be reported.

When at least one DSR is pending, a MAC layer device may operate as follows.

When at least one LCG among LCGs with a pending DSR or delay information to report is configured with two or more (i.e., multiple) remaining time threshold values (e.g., one or more reporting threshold values and one trigger threshold value):

Via an enhanced DSR MAC CE, the delay status/information of every LCG having a pending DSR or delay information to report may be reported.

Otherwise:

Via a legacy DSR MAC CE, the delay status/information of every LCG having a pending DSR may be reported.

Herein, one MAC PDU may include at most one DSR MAC CE (including both a legacy DSR MAC CE and an enhanced MAC CE).

A PDCP SDU in an associated relationship with one DSR may satisfy the following conditions.

This may be required to have never been transmitted via a MAC PDU.

The corresponding DSR may be required to be a delay-critical PDCP SDU of a triggered LCH.

A remaining PDCP discardTimer time of the corresponding PDCP SDU may be required to be less than the highest remaining time threshold value (e.g., the highest value among all reporting threshold values and trigger threshold values) configured for an LCG to which the corresponding LCH belongs.

In the following cases, a MAC layer device may cancel a pending DSR.

When all PDCP SDUs associated with the corresponding DSR are discarded.

When a MAC PDU is transmitted, and the corresponding MAC PDU includes a legacy DSR MAC CE or enhanced DSR MAC CE, wherein the corresponding legacy DSR MAC CE or enhanced DSR MAC CE includes delay information of all PDCP SDUs associated with the corresponding DSR.

When a MAC PDU is transmitted, and the corresponding MAC PDU includes all PDCP SDUs associated with the corresponding DSR.

A delay-critical PDCP SDU may be defined as follows.

When pdu-SetDiscard is not configured, a PDCP SDU of which a remaining time until the expiration of discardTimer is less than a remaining time threshold value (e.g., remainingTimeThreshold, trigger threshold value) configured for a corresponding LCG.

When pdu-SetDiscard is configured, a PDCP SDU included in a PDU set including at least one PDCP SDU of which a remaining time until the expiration of discardTimer is less than a remaining time threshold value (e.g., remainingTimeThreshold, trigger threshold value).

For MAC delay status reporting, a transmission PDCP layer device may include the following data in Delay-Critical PDCP Data Volume.

Delay-critical PDCP SDUs that are not yet generated as a PDCP data PDU.

PDCP data PDUs including a delay-critical PDCP SDU not yet transmitted to a lower layer.

PDCP control PDUs.

PDCP SDUs of an acknowledged mode (AM) DRB to be retransmitted according to the relevant standard.

PDCP data PDUs of an AM DRB to be retransmitted according to the relevant standard.

A delay-critical RLC SDU may be an RLC SDU corresponding to a PDCP PDU indicated as delay-critical by the upper PDCP layer.

According to an embodiment of the disclosure, for MAC buffer status reporting, a UE may include the following data in Delay-Critical RLC Data Volume.

Delay-critical RLC SDUs and delay-critical RLC SDU segments that are not yet included in an RLC data PDU.

RLC data PDUs including a delay-critical RLC SDU or delay-critical RLC SDU segment, which are pending for initial transmission.

RLC data PDUs that are pending for retransmission in an RLC AM.

When a status PDU is triggered and a t-StatusProhibit timer is not operating or expires, the UE may predict a size of a status PDU to be transmitted in a subsequent transmission opportunity and may include the predicted size in Delay-Critical RLC Data Volume.

According to an embodiment of the disclosure, delay-critical data may be data included in Delay-Critical PDCP Data Volume and Delay-Critical RLC Data Volume in the PDCP and RLC layers. For example, non-delay-critical data may be all or a portion of the other data excluding delay-critical data.

The non-delay-critical data may include all or a portion of the following types of data.

Type 1: When a remaining time of a running PDCP discardTimer of a corresponding PDCP SDU among the PDCP SDU/PDCP PDU/RLC SDU/RLC PDU is greater than or greater than or equal to the greatest remaining time threshold value (e.g., greatest value among trigger threshold value and a reporting threshold value) configured for an LCG to which the corresponding data belongs. A PDCP SDU that does not belong to a delay-critical PDCP SDU may be regarded as a non-delay-critical PDCP SDU.

Type 2: When the corresponding PDCP SDU among the PDCP SDU/PDCP PDU/RLC SDU/RLC PDU belongs to a low important PDU set and discardTimerForLowImportance is configured, and PSI based SDU discard is enabled.

Type 3: Data of the following cases, for example, RLC data PDUs (RLC AM) that are pending for retransmission, a status PDU estimated to be transmitted in a subsequent transmission opportunity when a status PDU is triggered and t-StatusProhibit is not performed or expires, PDCP control PDUs, PDCP SDUs retransmitted according to the relevant standard in an AM DRB, and PDCP data PDUs retransmitted in an AM DRB. For example, non-delay critical data reported via a legacy DSR or enhanced DSR may include only type 3.

When all or a portion of non-delay-critical data (e.g., data corresponding to type 1, type 2, or type 3 described above) satisfies a predetermined condition, a corresponding size may be included in a buffer size field and may be reported via a legacy DSR MAC CE or enhanced DSR MAC CE. The condition may include the following cases.

When it is non-delay-critical data for which scheduling/resource allocation is performed preferentially over (at least one) delay-critical data. The case may include the case in which, when delay-critical data and non-delay-critical data belong to the same LCH, the non-delay-critical data arrives earlier than the delay-critical data, at an RLC buffer (e.g., initial transmission pending buffer) and/or a PDCP buffer corresponding to the corresponding LCH. The case may indicate non-delay-critical data included in an LCH with a higher priority level than a priority (e.g., additional priority) of an LCH including delay-critical data.

When reporting a non-delay-critical data size via a legacy DSR MAC CE or enhanced DSR MAC CE, the UE may apply at least one of the following options.

Option 1 adds a non-delay-critical data dedicated buffer size field (e.g., non-delay-critical buffer size) for each LCG/cell group, other than the buffer size field of FIG. 4 or FIG. 6 of the disclosure, configures a size of the corresponding field to a non-delay-critical data size to be reported, and performs reporting. The UE may configure a remaining time field corresponding to the corresponding (non-delay-critical) buffer size field to 0, so as to indicate that the corresponding buffer size is a buffer size field reporting a non-delay-critical data size (satisfying a reporting condition). A combination of the remaining time and the (non-delay-critical) buffer size field may be reported by being always included at the foremost or last portion of the delay status information of the corresponding LCG.

Option 2 performs reporting by including a non-delay-critical data size satisfying a reporting condition in a delay-critical data size.

Option 2-1 includes a size of non-delay-critical data to report when calculating a buffer size field size of a corresponding LCG in a legacy DSR MAC CE, or includes the same only for a remaining time interval corresponding to a delay-critical data size greater than 0 (not 0) when calculating a buffer size field size corresponding to all corresponding remaining time intervals in an enhanced DSR MAC CE. With respect to an LCG that does not have delay-critical data to report, non-delay critical data may be not reported.

Option 2-2 includes a size of non-delay critical data to report when calculating a buffer size field size in an enhanced DSR MAC CE, only for a remaining time interval corresponding to a delay-critical data size greater than 0 (not 0) and only for a remaining time interval with the lowest or the greatest remaining time threshold value which are regarded as an upper limit or lower limit among the corresponding remaining time intervals.

Option 2-3 includes a non-delay-critical data size when calculating a buffer size field corresponding to a remaining time interval to which delay-critical data, located immediately before or after the corresponding non-delay-critical data, belongs to, for each non-delay-critical data based on a resource allocation/scheduling order.

The UE may perform measurement according to a measurement configuration configured by the BS. When a predetermined condition (e.g., event trigger scheme or periodic scheme) is satisfied, the UE may report a measurement result to the BS, and the BS may determine whether handover is needed for the UE based on the measurement report from the UE, and may determine a target cell of handover when handover is needed.

To perform measurement in a frequency different from the current communication frequency, the UE may need a measurement gap. Herein, a time interval used for measurement may be referred to as a measurement gap.

The BS may include a measurement configuration (measConfig) in a predetermined RRC message (e.g., RRCReconfiguration) to be transmitted to the UE, and may include a measurement gap configuration (measGapConfig) in the measurement configuration, so as to configure a measurement gap for the UE.

The BS may configure the measurement configuration (MeasConfig) as shown in Table 1 below.

TABLE 1

| | |
|---|---|
| MeasConfig ::= | SEQUENCE { |

| | |
|---|---|
| measObjectToRemoveList | MeasObjectToRemoveList |

OPTIONAL, -Need N

| | |
|---|---|
| measObjectToAddModList | MeasObjectToAddModList |

OPTIONAL, -Need N

| | |
|---|---|
| reportConfigToRemoveList | ReportConfigToRemoveList |

OPTIONAL, -Need N
reportConfigToAddModList
ReportConfigToAddModList
OPTIONAL, -Need N

| | |
|---|---|
| measIdToRemoveList | MeasIdToRemoveList |

OPTIONAL, -Need N

| | |
|---|---|
| measIdToAddModList | MeasIdToAddModList |

OPTIONAL, -Need N

| | |
|---|---|
| s-MeasureConfig | CHOICE { |
| ssb-RSRP | RSRP-Range, |
| csi-RSRP | RSRP-Range |

}
OPTIONAL, -Need M

| | |
|---|---|
| quantityConfig | QuantityConfig |

OPTIONAL, -Need M

| | |
|---|---|
| measGapConfig | MeasGapConfig |

OPTIONAL, -Need M

| | |
|---|---|
| measGapSharingConfig | MeasGapSharingConfig |

```
OPTIONAL, -Need M
    ...,
    [[
```

| | |
|---|---|
| interFrequencyConfig-NoGap-r16 | ENUMERATED {true} |

```
OPTIONAL -Need R
    ]],
    [[
```

| | |
|---|---|
| effectiveMeasWindowConfig-r18 | SetupRelease |
| {MeasWindowConfig-r18} | OPTIONAL |

```
-Need M
    ]]
  }
```

The measurement gap configuration (MeasGapConfig) may have a structure as shown in Table 2 below.

TABLE 2

| | |
|---|---|
| MeasGapConfig ::= | SEQUENCE { |

| | |
|---|---|
| gapFR2 | SetupRelease { GapConfig } |

```
OPTIONAL, -Need M
    ...,
    [[
```

| | |
|---|---|
| gapFR1 | SetupRelease { GapConfig } |

OPTIONAL, -Need M

| | |
|---|---|
| gapUE | SetupRelease { GapConfig } |

```
OPTIONAL -Need M
    ]],
    [[
```

| | |
|---|---|
| gapToAddModList-r17 | SEQUENCE (SIZE (1..maxNrofGapId- |

| | |
|---|---|
| r17)) OF GapConfig-r17 | OPTIONAL, -Need N |

| | |
|---|---|
| gapToReleaseList-r17 | SEQUENCE (SIZE (1..maxNrofGapId- |

| | |
|---|---|
| r17)) OF MeasGapId-r17 | OPTIONAL, -Need N |

```
    posMeasGapPreConfigToAddModList-r17
PosMeasGapPreConfigToAddModList-r17
OPTIONAL, -Need N
    posMeasGapPreConfigToReleaseList-r17
PosMeasGapPreConfigToReleaseList-r17
OPTIONAL -Need N
    ]]
  }
```

| | |
|---|---|
| GapConfig ::= | SEQUENCE { |
| gapOffset | INTEGER (0..159), |

| | |
|---|---|
| mgl | ENUMERATED {ms1dot5, |

ms3, ms3dot5, ms4, ms5dot5, ms6},

| | |
|---|---|
| mgrp | ENUMERATED {ms20, ms40, |

ms80, ms160},

| | |
|---|---|
| mgta | ENUMERATED {ms0, |

```
ms0dot25, ms0dot5},
    ...,
    [[
```

| | |
|---|---|
| refServCellIndicator | ENUMERATED {pCell, pSCell, |
| mcg-FR2} | OPTIONAL -Cond NEDCorNRDC |

```
    ]],
    [[
```

| | |
|---|---|
| refFR2ServCellAsyncCA-r16 | ServCellIndex |

OPTIONAL, -Cond AsyncCA

| | |
|---|---|
| mgl-r16 | ENUMERATED {ms10, ms20} |

```
OPTIONAL -Cond PRS
    ]]
  }
```

| | |
|---|---|
| GapConfig-r17 ::= | SEQUENCE { |
| measGapId-r17 | MeasGapId-r17, |

| | |
|---|---|
| gapType-r17 | ENUMERATED {perUE, |

perFR1, perFR2},

| | |
|---|---|
| gapOffset-r17 | INTEGER (0..159), |

| | |
|---|---|
| mgl-r17 | ENUMERATED {ms1, ms1dot5, |

ms2, ms3, ms3dot5, ms4, ms5, ms5dot5, ms6, ms10, ms20},

| | |
|---|---|
| mgrp-r17 | ENUMERATED {ms20, ms40, |

ms80, ms160},

| | |
|---|---|
| mgta-r17 | ENUMERATED {ms0, |

ms0dot25, ms0dot5, ms0dot75},

| | |
|---|---|
| refServCellIndicator-r17 | ENUMERATED {pCell, pSCell, |
| mcg-FR2} | OPTIONAL, -Cond NEDCorNRDC |
| refFR2-ServCellAsyncCA-r17 | ServCellIndex |

OPTIONAL, -Cond AsyncCA

| | |
|---|---|
| preConfigInd-r17 | ENUMERATED {true} |

OPTIONAL, -Need R

| | |
|---|---|
| ncsgInd-r17 | ENUMERATED {true} |

OPTIONAL, -Need R

| | |
|---|---|
| gapAssociationPRS-r17 | ENUMERATED {true} |

OPTIONAL, -Need R

| | |
|---|---|
| gapSharing-r17 | MeasGapSharingScheme |

OPTIONAL, -Need R

| | |
|---|---|
| gapPriority-r17 | GapPriority-r17 |

```
OPTIONAL, -Need R
      ...
  }
```

| | | |
|---|---|---|
| PosMeasGapPreConfigToAddModList-r17 | ::= | SEQUENCE (SIZE |

(1..maxNrofPreConfigPosGapId-r17)) OF PosGapConfig-r17

| | | |
|---|---|---|
| PosMeasGapPreConfigToReleaseList-r17 | ::= | SEQUENCE (SIZE |

(1..maxNrofPreConfigPosGapId-r17)) OF MeasPosPreConfigGapId-r17

| | |
|---|---|
| PosGapConfig-r17 ::= | SEQUENCE { |
| measPosPreConfigGapId-r17 | MeasPosPreConfigGapId-r17, |
| gapOffset-r17 | INTEGER (0..159), |

| | |
|---|---|
| mgl-r17 | ENUMERATED {ms1dot5, ms3, |

ms3dot5, ms4, ms5dot5, ms6, ms10, ms20},

| | |
|---|---|
| mgrp-r17 | ENUMERATED {ms20, ms40, |

ms80, ms160},

| | |
|---|---|
| mgta-r17 | ENUMERATED {ms0, |

ms0dot25, ms0dot5},

| | |
|---|---|
| gapType-r17 | ENUMERATED {perUE, |

```
perFR1, perFR2},
    ...
  }
  MeasPosPreConfigGapId-r17 ::= INTEGER (1..maxNrofPreConfigPosGapId-r17)
```

The BS may configure a measurement gap that is skippable (when a predetermined condition is satisfied) in a predetermined RRC message (e.g., RRCReconfiguration). The BS may indicate a measurement gap(s) skippable when a predetermined condition is satisfied, by using a list including measurement gap IDs (MeasGapId-r17) of all or a portion of configured measurement gaps. The BS may add a predetermined field (e.g., skipEnabled) to measurement gap configuration information (e.g., GapConfig, GapConfig-r17, PosGapConfig-r17), so as to indicate that an occasion of the corresponding measurement gap is skippable when a predetermined condition is satisfied.

The BS may perform configuration so that a predetermined period and pattern (e.g., bitmap) is applied to all or a portion of a measurement gap configuration so that a predetermined measurement gap occasion (e.g., a measurement gap occasion configured to 1 or 0 in bitmap) is skipped/skippable periodically. A measurement gap to which the skip pattern is to be applied may be configured according to a method of adding, by the BS, a predetermined indicator to a corresponding measurement gap configuration or adding an indicator including one or more measurement gap IDs for application.

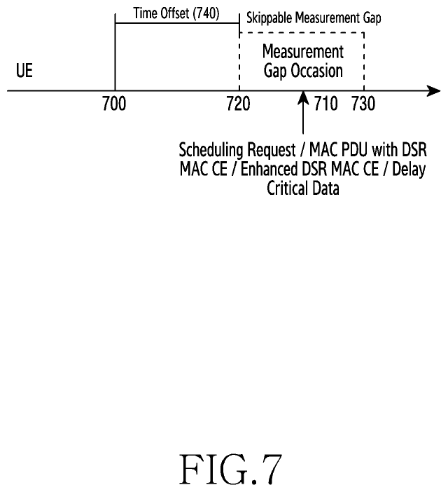

FIG. 7 illustrates a method of skipping a measurement gap occasion by a UE according to an embodiment.

Referring to FIG. 7, the case in which an occasion of a measurement gap configured to be skippable is skippable may include at least one of the following cases.

A BS adds a predetermined indicator/bit to DCI, so as to indicate skipping a first measurement gap occasion occurring after a predetermined time offset 740 based on a DCI transmission/reception point or skipping a first measurement gap occasion belonging to a skippable measurement gap. The time offset may be in a previously defined size. The time offset may be a value that the BS is capable of configuring via a predetermined RRC message (e.g., RRCReconfiguration).

When SR transmission triggered by a DSR/enhanced DSR overlaps with a measurement gap occasion, and the measurement gap occasion belongs to a skippable measurement gap or a skippable measurement gap occasion, the UE may skip the corresponding measurement gap occasion and may perform SR transmission. The point in time at which the UE determines whether to skip the measurement gap occasion may be a point 700 that is at least the predetermined time offset 740 ahead of a start point 720 of the corresponding measurement gap occasion.

The time offset may be in a previously defined size and may be a value that the BS is capable of configuring via a predetermined RRC message (e.g., RRCReconfiguration). The measurement gap occasion skipping may be performed for SR transmission only for an LCH/LCG that the BS indicates via a predetermined RRC message (e.g., RRCReconfiguration). For example, via a predetermined RRC message (e.g., RRCReconfiguration), the BS may perform configuration by adding a predetermined indicator to an LCH configuration or adding an indicator including one or more LCH/LCG IDs, so as to perform the measurement gap occasion skipping for the SR transmission triggered by a DSR trigger of the corresponding LCH.

When MAC PDU transmission (e.g., initial transmission/retransmission by configured grant or dynamic UL grant) including (multiplexed with) a DSR/enhanced DSR MAC CE overlaps with a measurement gap occasion, and the measurement gap occasion belongs to a skippable measurement gap or a skippable measurement gap occasion, the UE may skip the corresponding measurement gap occasion and perform MAC PDU transmission. The point in time at which the UE determines whether to skip the measurement gap occasion may be the point 700 that is at least the predetermined time offset 740 ahead of the start point 720 of the corresponding measurement gap occasion.

The time offset may be in a previously defined size and may be a value that the BS is capable of configuring via a predetermined RRC message (e.g., RRCReconfiguration). For example, only for an LCH/LCG that the BS indicates via a predetermined RRC message (e.g., RRCReconfiguration), for MAC PDU transmission including (multiplexed with) a DSR/enhanced DSR MAC CE including delay information of the corresponding LCH/LCG, the measurement gap occasion skipping may be performed. For example, via a predetermined RRC message (e.g., RRCReconfiguration), the BS may perform configuration by adding a predetermined indicator to an LCH configuration or adding an indicator including one or more LCH/LCG IDs, so as to perform the measurement gap occasion skipping for the MAC PDU transmission including (multiplexed with) a DSR/enhanced DSR MAC CE including delay information of the corresponding LCH/LCG. For example, only for a DSR/enhanced DSR MAC CE that has never been SR triggered/transmitted, the measurement gap occasion skipping may be performed.

When MAC PDU transmission (e.g., initial transmission/retransmission by configured grant or dynamic UL grant) including delay-critical UL data overlaps with a measurement gap occasion, and the measurement gap occasion belongs to a skippable measurement gap, the UE may skip the corresponding measurement gap occasion and may perform MAC PDU transmission. The point in time at which the UE determines whether to skip the measurement gap occasion may be the point 700 that is at least the predetermined time offset 740 ahead of the start point 720 of the corresponding measurement gap occasion. The time offset may be in a previously defined size. The time offset may be a value that the BS is capable of configuring via a predetermined RRC message (e.g., RRCReconfiguration). For example, only for an LCH/LCG that the BS indicates via a predetermined RRC message (e.g., RRCReconfiguration), to perform MAC PDU transmission including delay-critical UL data of the corresponding LCH/LCG, the measurement gap occasion skipping may be performed. For example, via a predetermined RRC message (e.g., RRCReconfiguration), the BS may perform configuration by adding a predetermined indicator to an LCH configuration or adding an indicator including one or more LCH/LCG IDs, so as to perform the measurement gap occasion skipping for MAC PDU transmission including delay-critical UL data of the corresponding LCH/LCG. For example, only when SR triggering/transmission is not performed by the corresponding delay-critical UL data and/or when the corresponding delay-critical UL data has not been reported via a DSR/enhanced DSR MAC CE, the measurement gap occasion skipping may be performed.

When the measurement gap occasion is skipped, the UE may perform at least one of the following operations during the corresponding measurement gap occasion.

HARQ feedback, SR, and CSI transmission.

Sounding reference signal (SRS) reporting.

Transmission on a UL-SCH, excluding Msg3 or MsgA payload.

PDCCH monitoring.

DL-SCH reception.

A MAC layer device of the UE may operate as follows.

During an activated measurement gap that [has not been indicated by lower layers as skipped] or [has not been skipped], the MAC entity shall, on the Serving Cell(s) in the corresponding frequency range of the measurement gap configured by measGapConfig as specified in the relevant standard:
1> do not perform the transmission of HARQ feedback, SR, and CSI;
1> do not report SRS;
1> do not transmit on UL-SCH except for Msg3 or the MsgA payload as specified in the relevant standard;
1> if the ra-ResponseWindow or the ra-ContentionResolutionTimer or the msgB-Response Window is running, or if there is an ongoing RACH-less LTM cell switch, or if there is an ongoing RACH-less handover:
2> monitor the PDCCH as specified in the relevant standard.
1> else:
2> do not monitor the PDCCH;
2> do not receive on DL-SCH.

The MAC layer device of the UE may operate as follows.

To generate a transmission for a TB, the HARQ process shall:
1> if the MAC PDU was obtained from the Msg3 buffer; or
1> if the MAC PDU was obtained from the MsgA buffer; or
1> if there is no measurement gap that [is activated] or [is activated and has not been indicated by lower layers as skipped] or [has not been indicated by lower layers as skipped] or [has not been skipped] at the time of the transmission and, in case of retransmission, the retransmission does not collide with a transmission for a MAC PDU obtained from the Msg3 buffer or the MsgA buffer:
2> if there are neither NR sidelink transmission nor transmission of V2X sidelink communication at the time of the transmission; or
2> if the transmission of the MAC PDU is prioritized over sidelink transmission or can be simultaneously performed with sidelink transmission:
3> instruct the physical layer to generate a transmission according to the stored UL grant.

The MAC layer device of the UE may operate as follows.
1> if the Long DRX cycle is used for a DRX group and the drx-NonIntegerLongCycleStartOffset is configured, and floor ([(DRX_SFN_COUNTER×10240)+(SFN×10)+subframe number] modulo (drx-NonIntegerLongCycle))=drx-StartOffset:
2> if DCP monitoring is configured for the active DL BWP as specified in the relevant standard:
3> if DCP indication associated with the current DRX cycle received from lower layer indicated to start drx-onDurationTimer, as specified in the relevant standard; or
3> if all DCP occasion(s) in time domain, as specified in the relevant standard, associated with the current DRX cycle occurred in Active Time considering grants/assignments/DRX Command MAC CE/Long DRX Command MAC CE received and Scheduling Request sent until 4 ms prior to start of the last DCP occasion, or during a measurement gap that [is activated] or [is activated and has not been indicated by lower layers as skipped] or [has not been indicated by lower layers as skipped] or [has not been skipped], or when the MAC entity monitors for a PDCCH transmission on the search space indicated by recoverySearchSpaceId of the SpCell identified by the C-RNTI while the ra-Response Window is running (as specified in the relevant standard); or
3> if ps-Wakeup is configured with value true and DCP indication associated with the current DRX cycle has not been received from lower layers:
4> start drx-onDurationTimer after drx-SlotOffset from the beginning of the subframe.

The MAC layer device of the UE may operate as follows.

As long as at least one SR is pending, the MAC entity shall for each pending SR:
1> if the MAC entity has no valid PUCCH resource configured for the pending SR; and
1> if there is no ongoing RACH-less LTM cell switch; and
1> if rach-LessHO is not configured:
2> initiate a Random Access procedure on the SpCell and cancel the pending SR.
1> else, for the SR configuration corresponding to the pending SR:
2> when the MAC entity has an SR transmission occasion on the valid PUCCH resource for SR configured; and
2> if sr-ProhibitTimer is not running at the time of the SR transmission occasion; and
2> if the PUCCH resource for the SR transmission occasion does not overlap with a measurement gap that [is activated] or [is activated and has not been indicated by lower layers as skipped] or [has not been indicated by lower layers as skipped] or [has not been skipped]:
3> if the PUCCH resource for the SR transmission occasion overlaps with neither a UL-SCH resource whose simultaneous transmission with the SR is not allowed by configuration of simultaneousPUCCH-PUSCH or simultaneousPUCCH-PUSCH-Secondary PUCCHgroup or simultaneousSR-PUSCH-diffPUCCH-Groups or simultaneousPUCCH-PUSCH-SamePriority or simultaneousPUCCH-PUSCH-SamePriority-SecondaryPUCCHgroup nor an SL-SCH resource; or
3> if the MAC entity is able to perform this SR transmission simultaneously with the transmission of the SL-SCH resource; or
3> if the MAC entity is configured with Ich-basedPrioritization, and the PUCCH resource for the SR transmission occasion does not overlap with the PUSCH duration of an UL grant received in a random access response or with the PUSCH duration of an UL grant addressed to Temporary C-radio network temporary identifier (RNTI) or with the PUSCH duration of a MsgA payload, and the PUCCH resource for the SR transmission occasion for the pending SR triggered as specified in the relevant standard overlaps with any other UL-SCH resource(s), and the physical layer can signal the SR on one valid PUCCH resource for SR, and the priority of the logical channel that triggered SR is higher than the priority of the UL grant(s) for any UL-SCH resource(s) where the UL grant was not already de-prioritized and its simultaneous transmission with the SR is not allowed by configuration of simultaneousPUCCH-PUSCH or simultaneousPUCCH-PUSCH-SecondaryPUCCHgroup or simultaneousSR-PUSCH-diffPUCCHgroups or simultaneousPUCCH-PUSCH-SamePriority or simultaneousPUCCH-PUSCH-SamePriority-SecondaryPUCCHgroup, and the priority of the UL grant is determined as specified in the relevant standard; or
3> if both sl-PrioritizationThres and ul-PrioritizationThres are configured and the PUCCH resource for the SR transmission occasion for the pending SR triggered as specified in clause 5.22.1.5 overlaps with any UL-SCH resource(s) carrying a MAC PDU, and the value of the priority of the triggered SR determined as specified in the relevant standard is lower than sl-Prioritization Thres and the value of the highest priority of the logical channel(s) in the MAC PDU is greater than or equal to ul-PrioritizationThres and any MAC CE prioritized as described in the relevant standard is not included in the MAC PDU and the MAC PDU is not prioritized by upper layer according to the relevant standard; or
3> if an SL-SCH resource overlaps with the PUCCH resource for the SR transmission occasion for the pending SR triggered as specified in the relevant standard, and the MAC entity is not able to perform this SR transmission simultaneously with the transmission of the SL-SCH resource, and either transmission on the SL-SCH resource is not prioritized as described in the relevant standard or the priority value of the logical channel that triggered SR is lower than ul-PrioritizationThres, if configured; or
3> if an SL-SCH resource overlaps with the PUCCH resource for the SR transmission occasion for the pending SR triggered as specified in the relevant standard, and the MAC entity is not able to perform this SR transmission simultaneously with the transmission of the SL-SCH resource, and the priority of the triggered SR determined as specified in the relevant standard is higher than the priority of the MAC PDU determined as specified in the relevant standard for the SL-SCH resource; or
3> if an SL-PRS resource overlaps with the PUCCH resource for the SR transmission occasion for the pending SR triggered as specified in the relevant standard, and the MAC entity is not able to perform this SR transmission simultaneously with the transmission of the SL-PRS resource, and either transmission on the SL-PRS resource is not prioritized as described in the relevant standard or the priority value of the logical channel that triggered SR is lower than ul-PrioritizationThres, if configured; or
3> if an SL-PRS resource overlaps with the PUCCH resource for the SR transmission occasion for the pending SR triggered as specified in clause 5.22.1.5, and the MAC entity is not able to perform this SR transmission simultaneously with the transmission of the SL-PRS resource, and the priority of the triggered SR determined as specified in the relevant standard is higher than the priority of the MAC PDU and SL-PRS, if available, determined as specified in the relevant standard for the SL-PRS resource:
4> consider the SR transmission as a prioritized SR transmission.
4> consider the other overlapping UL grant(s), if any, as a de-prioritized UL grant(s), except for the overlapping UL grant(s) whose simultaneous transmission is allowed by configuration of simultaneousPUCCH-PUSCH or simultaneousPUCCH-PUSCH-Secondary PUCCHgroup or simultaneousSR-PUSCH-diffPUCCH-Groups or simultaneousPUCCH-PUSCH-SamePriority or simultaneousPUCCH-PUSCH-SamePriority-Secondary PUCCHgroup;
4> if the de-prioritized UL grant(s) is a configured UL grant configured with autonomousTx whose PUSCH has already started:
5> stop the configuredGrantTimer for the corresponding HARQ process of the de-prioritized UL grant(s);
5> stop the cg-Retransmission Timer for the corresponding HARQ process of the de-prioritized UL grant(s).
4> if SR_COUNTER<sr-TransMax:
5> instruct the physical layer to signal the SR on one valid PUCCH resource for SR;
5> if LBT failure indication is not received from lower layers:
6> increment SR_COUNTER by 1;
6> start the sr-ProhibitTimer.
5> else if lbt-FailureRecoveryConfig is not configured:
6> increment SR_COUNTER by 1.
4> else:
5> notify RRC to release PUCCH for all serving cells;
5> notify RRC to release SRS for all serving cells;
5> clear any configured DL assignments and UL grants;
5> clear any PUSCH resources for semi-persistent CSI reporting;
5> if rach-LessHO is not configured and if there is no ongoing RACH-less LTM cell switch:
6> initiate a random access procedure in the relevant standard on the SpCell and cancel all pending SRs.
3> else:
4> consider the SR transmission as a de-prioritized SR transmission.

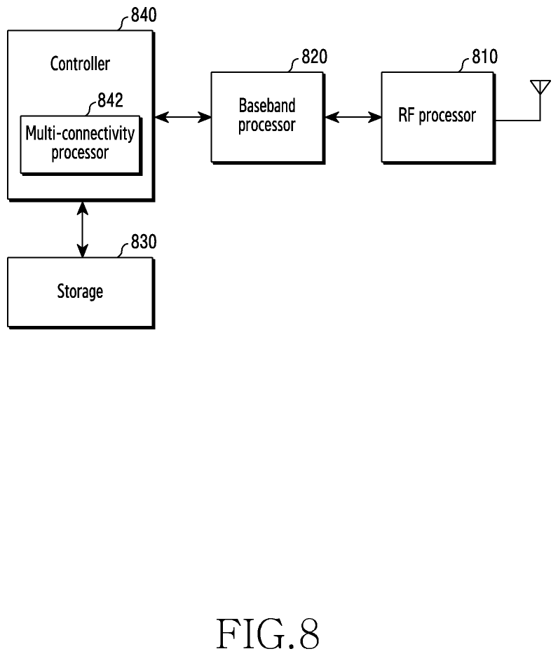

FIG. 8 illustrates a UE device according to an embodiment.

Referring to FIG. 8, the UE may include a radio frequency (RF) processor 810, a baseband processor 820, a storage 830, and a controller 840. The structure of the UE is not limited to the exemplary structure illustrated in FIG. 8, and the UE may include a larger or smaller number of components than those illustrated in FIG. 8.

The RF processor 810 may perform a function for transmitting and receiving a signal via a wireless channel, such as band conversion and amplification of the signal. The RF processor 810 may up-convert a baseband signal provided from the baseband processor 820 to an RF band signal and then transmit the same through an antenna, and may down-convert an RF band signal received through the antenna to a baseband signal. The RF processor 810 may include, but not limited to, a transmission filter, a reception filter, an amplifier, a mixer, an oscillator, a digital-to-analog converter (DAC), an analog-to-digital converter (ADC), and the like. Although only one antenna is illustrated in FIG. 8, the UE may include multiple antennas. In addition, the RF processor 810 may include multiple RF chains. The RF processor 810 may perform beamforming. For the beamforming, the RF processor 810 may adjust the phase and magnitude of each of signals transmitted and received through multiple antennas or antenna elements. In addition, the RF processor 810 may perform MIMO, and may receive multiple layers when performing MIMO operations.

The baseband processor 820 may perform functions of conversion between baseband signals and bitstrings according to the system's physical layer specifications. For example, during data transmission, the baseband processor 820 may encode and modulate a transmitted bitstring to generate complex symbols. During data reception, the baseband processor 820 may demodulate and decode a baseband signal provided from the RF processor 810 to restore a received bitstring. When following the OFDM scheme, during data transmission, the baseband processor 820 may encode and modulate a transmitted bitstring to generate complex symbols, may map the complex symbols to subcarriers, and may configure OFDM symbols through an inverse fast Fourier transform (IFFT) operation and cyclic prefix (CP) insertion. During data reception, the baseband processor 820 may split a baseband signal provided from the RF processor 810 at the OFDM symbol level, may restore signals mapped to subcarriers through a fast Fourier transform (FFT) operation, and may restore a received bitstring through demodulation and decoding.

The baseband processor 820 and the RF processor 810 may transmit and receive signals as described above. Therefore, the baseband processor 820 and the RF processor 810 may be referred to as a transmitter, a receiver, a transceiver, or a communication unit. Furthermore, at least one of the baseband processor 820 and the RF processor 810 may include multiple communication modules to support multiple different radio access technologies. In addition, at least one of the baseband processor 820 and the RF processor 810 may include different communication modules to process signals in different frequency bands. The different radio access technologies may include a wireless LAN, a cellular network (e.g., LTE), and the like. In addition, the different frequency bands may include super high frequency (SHF) (e.g., 2 NRHz) bands and millimeter wave (mmWave) (e.g., 60 GHz) bands. The UE may transmit/receive a signal with the BS by using the baseband processor 820 and the RF processor 810, and the signal may include control information and data.

The storage 830 may store basic programs, application programs, and data, such as configuration information, for the operation of the UE. The storage 830 may store basic programs, application programs, and data information, such as configuration information, for the operation of the UE. In addition, the storage 830 may provide the stored data at the request of the controller 840.

The storage 830 may include storage media such as a ROM, a RAM, a hard disk, a CD-ROM, and a DVD, or a combination of storage media. In addition, the storage 830 may be configured by multiple memories. The storage 830 may store programs for performing the handover method according to the disclosure.

The controller 840 may control the overall operation of the UE. The controller 840 may transmit/receive signals through the baseband processor 820 and the RF processor 810.

In addition, the controller 840 records data in the storage 830 and reads the data from the storage 830. To this end, the controller 840 may include at least one processor. The controller 840 may include a communication processor configured to perform control for communication, and an application processor (AP) configured to control upper layers such as application programs. The controller 840 may include a multi-connectivity processor 842 configured to process processes operating in a multi-connectivity mode. In addition, at least one component in the UE may be implemented as a single chip.

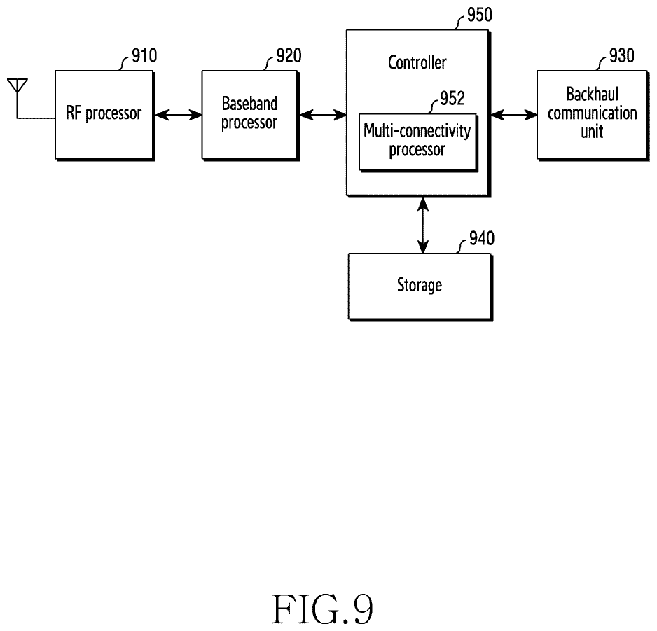

FIG. 9 illustrates a BS device according to an embodiment.

Referring to FIG. 9, the BS may include an RF processor 910, a baseband processor 920, a backhaul communication unit 930, a storage 940, and a controller 950. The structure of the BS is not limited to the exemplary structure illustrated in FIG. 9, and the BS may include a larger or smaller number of components than those illustrated in FIG. 9. The RF processor 910 may perform a function for transmitting and receiving a signal via a wireless channel, such as band conversion and amplification of the signal. The RF processor 9-10 may up-convert a baseband signal provided from the baseband processor 920 to an RF band signal, may transmit the same through an antenna, and may down-convert an RF band signal received through the antenna to a baseband signal. The RF processor 910 may include a transmission filter, a reception filter, an amplifier, a mixer, an oscillator, a DAC, and an ADC. Although only one antenna is illustrated in FIG. 9, the RF processor 910 may include multiple antennas. In addition, the RF processor 910 may include multiple RF chains. The RF processor 910 may perform beamforming. For the beamforming, the RF processor 910 may adjust the phase and magnitude of each of signals transmitted and received through multiple antennas or antenna elements. The RF processor 910 may transmit one or more layers to perform a downward MIMO operation.

The baseband processor 920 may perform functions of conversion between baseband signals and bitstrings according to the system's physical layer specifications. For example, during data transmission, the baseband processor 920 may encode and modulate a transmitted bitstring to generate complex symbols. During data reception, the baseband processor 920 may demodulate and decode a baseband signal provided from the RF processor 910 to restore a received bitstring. When following the OFDM scheme, during data transmission, the baseband processor 920 may encode and modulate a transmitted bitstring to generate complex symbols, may map the complex symbols to subcarriers, and may configure OFDM symbols through an IFFT operation and CP insertion. During data reception, the baseband processor 920 may split a baseband signal provided from the RF processor 910 at the OFDM symbol level, may restore signals mapped to subcarriers through FFT operation, and may restore a received bitstring through demodulation and decoding. The baseband processor 920 and the RF processor 910 may transmit and receive signals as described above. Therefore, the baseband processor 920 and the RF processor 910 may be referred to as a transmitter, a receiver, a transceiver, a communication unit, or a wireless communication unit. The BS may transmit/receive a signal with the UE by using the baseband processor 920 and the RF processor 910, and the signal may include control information and data.

The backhaul communication unit 930 may provide an interface for performing communication with other nodes within a network. The backhaul communication unit 930 may convert bitstrings transmitted from the main BS to other nodes, an auxiliary BS or a core network, to physical signals, and may convert physical signals received from the other nodes to bitstrings.

The storage 940 may store basic programs, application programs, and data, such as configuration information, for the operation of the main BS. The storage 940 may store information regarding a bearer allocated to a connected UE, a measurement result reported from the connected UE, and the like. The storage 940 may store information serving as a reference to determine whether to provide multi-connectivity to a UE or to suspend the same. The storage 940 may provide the stored data at the request of the controller 950. The storage 990 may include storage media such as a ROM, a RAM, a hard disk, a CD-ROM, and a DVD, or a combination of storage media. The storage 940 may be configured by multiple memories. The storage 940 may store programs for performing the handover method according to the disclosure.

The controller 950 may control the overall operation of the main BS. The controller 950 may transmit/receive signals through the baseband processor 920 and the RF processor 910 or through the backhaul communication unit 6-30. In addition, the controller 950 records data in the storage 940 and reads the data from the storage 940. To this end, the controller 950 may include at least one processor. In addition, the controller 950 may include a multi-connectivity processor 952 configured to process processes operating in a multi-connectivity mode.

Methods disclosed in the embodiments described in the specification may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, the programs may be stored in memories configured by any combination of some or all of them may form a memory in which the program is stored. In addition, each of the configured memories may include multiple memories.

The programs may be stored in an attachable storage device which can access the electronic device through communication networks such as the Internet, Intranet, local area network (LAN), Wide LAN (WLAN), and Storage Area Network (SAN) or a combination thereof. Such a storage device may access the electronic device via an external port. A separate storage device on the communication network may access a portable electronic device.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Each block in the flowchart illustrations may represent a module, segment, or portion of code, which includes one or more executable instructions for implementing the specified logical function(s). It should also be noted that in some alternative implementations, the functions noted in the blocks may occur out of the order. Two blocks shown in succession may in fact be executed substantially concurrently or the blocks may sometimes be executed in the reverse order, depending upon the functionality involved.

As used herein, the term unit refers to a software element or a hardware element, such as a field programmable gate array (FPGA) or an application specific integrated circuit (ASIC), and the units may perform certain functions. However, the unit does not always have a meaning limited to software or hardware. The units may be constructed either to be stored in an addressable storage medium or to execute one or more processors. Therefore, the unit includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the units may be either combined into a smaller number of elements, or a unit, or divided into a larger number of elements, or a unit. Moreover, the elements and units may be implemented to reproduce one or more central processing units (CPUs) within a device or a security multimedia card.

In the disclosure, the term computer program product or computer readable medium is used to generally refer to a medium such as a memory, a hard disk installed in a hard disk drive, or a signal. The computer program product or computer readable medium is an element that is provided to a method for reporting UE capability in a wireless communication system according to the disclosure.

The machine-readable storage medium may be provided in the form of a non-transitory storage medium, which indicates that the storage medium is a tangible device, and does not include a signal (e.g., an electromagnetic wave), but this term does not differentiate between where data is semi-permanently stored in the storage medium and where the data is temporarily stored in the storage medium. As an example, the non-transitory storage medium may include a buffer in which data is temporarily stored

Methods herein may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least a part of the computer program product (e.g., a downloadable app) may be temporarily generated or at least temporarily stored in the machine-readable storage medium, such as memory of the manufacturer's server, a server of the application store, or a relay server.

The above respective embodiments may be employed in combination, as necessary. A part of one embodiment of the disclosure may be combined with a part of another embodiment to operate a base station and a terminal. In addition, the embodiments of the disclosure may also be applied to other communication systems and other variants based on the technical idea of the embodiments may also be implemented. For example, the embodiments may be applied to LTE, 5G, NR, or 6G systems.

While the disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A method performed by a user equipment (UE) in a wireless communication system, the method comprising:
transmitting, to a base station, a first message including first information indicating that the UE supports a delay status report (DSR) using multiple reporting thresholds;
receiving, from the base station, a second message configuring a remaining time threshold for triggering the DSR for a first logical channel group (LCG) and at least one reporting threshold for reporting the DSR for the first LCG; and
transmitting, to the base station, a DSR medium access control (MAC) control element (CE) with multiple entries including the DSR for the first LCG.

2. The method of claim 1,
wherein each of the at least one reporting threshold is indicated based on a unit of milliseconds.

3. The method of claim 1,
wherein the DSR MAC CE with the multiple entries includes a first field indicating a shortest remaining time of buffered data associated with a corresponding reporting threshold at a time of a first symbol of a first physical uplink shared channel (PUSCH) transmission including the DSR MAC CE with the multiple entries.

4. The method of claim 3,
wherein the buffered data includes at least one packet data convergence protocol (PDCP) service data unit (SDU) that has not been transmitted in a MAC protocol data unit (PDU).

5. The method of claim 3,
wherein the DSR MAC CE with the multiple entries includes a second field indicating a size of the buffered data associated with the corresponding reporting threshold.

6. The method of claim 5,
wherein the DSR MAC CE with the multiple entries includes a third field indicating whether an additional pair of a remaining time field and a buffer size field for a reporting threshold is included in the DSR MAC CE with multiple entries after the second field.

7. The method of claim 1, further comprises:
if an uplink resource is not available to accommodate the DSR MAC CE with the multiple entries and there is no pending scheduling request triggered, triggering a scheduling request.

8. A method performed by a base station in a wireless communication system, the method comprising:
receiving, from a user equipment (UE), a first message including first information indicating that the UE supports a delay status report (DSR) using multiple reporting thresholds;
transmitting, to the UE, a second message configuring a remaining time threshold for triggering the DSR for first logical channel group (LCG) and at least one reporting threshold for reporting the DSR for the first LCG; and
receiving, from the UE, a DSR medium access control (MAC) control element (CE) with multiple entries including the DSR for the first LCG.

9. The method of claim 8,
wherein each of the at least one reporting threshold is indicated based on a unit of milliseconds.

10. The method of claim 8,
wherein the DSR MAC CE with the multiple entries includes a first field indicating a shortest remaining time of buffered data associated with a corresponding reporting threshold at a time of a first symbol of a first physical uplink shared channel (PUSCH) transmission including the DSR MAC CE with the multiple entries.

11. A user equipment (UE) comprising:
at least one transceiver;
at least one processor communicatively coupled to the at least one transceiver; and
at least one memory, communicatively coupled to the at least one processor, storing instructions executable by the at least one processor individually or in any combination to cause the UE to:
transmit, to a base station, a first message including first information indicating that the UE supports a delay status report (DSR) using multiple reporting thresholds,
receive, from the base station, a second message configuring a remaining time threshold for triggering the DSR for a first logical channel group (LCG) and at least one reporting threshold for reporting the DSR for the first LCG, and
transmit, to the base station, a delay status report medium access control (MAC) control element (CE) with multiple entries including the DSR for the first LCG.

12. The UE of claim 11,
wherein each of the at least one reporting threshold is indicated based on a unit of milliseconds.

13. The UE of claim 11,
wherein the DSR MAC CE with the multiple entries includes a first field indicating a shortest remaining time of buffered data associated with a corresponding reporting threshold at a time of a first symbol of a first physical uplink shared channel (PUSCH) transmission including the DSR MAC CE with the multiple entries.

14. The UE of claim 13,
wherein the buffered data includes at least one packet data convergence protocol (PDCP) service data unit (SDU) that has not been transmitted in a medium access control (MAC) protocol data unit (PDU).

15. The UE of claim 13,
wherein the DSR MAC CE with the multiple entries includes a second field indicating a size of the buffered data associated with the corresponding reporting threshold.

16. The UE of claim 15,
wherein the DSR MAC CE with the multiple entries includes a third field indicating whether an additional pair of a remaining time field and a buffer size field for a reporting threshold is included in the DSR MAC CE with the multiple entries after the second field.

17. The UE of claim 11, wherein the instructions further cause the UE to:
if an uplink resource is not available to accommodate the DSR MAC CE with the multiple entries, and there is no pending scheduling request triggered, trigger a scheduling request.

18. A base station comprising:
at least one transceiver;
at least one processor communicatively coupled to the at least one transceiver; and
at least one memory, communicatively coupled to the at least one processor, storing instructions executable by the at least one processor individually or in any combination to cause the base station to:
receive, from a user equipment (UE), a first message including first information indicating that the UE supports a delay status report (DSR) using multiple reporting thresholds,
transmit, to the UE, a second message configuring a remaining time threshold for triggering the DSR for a first logical channel group (LCG) and at least one reporting threshold for reporting the DSR for the first LCG; and
receive, from the UE, a DSR medium access control (MAC) control element (CE) with multiple entries including the DSR for the first LCG.

19. The base station of claim 18,
wherein each of the at least one reporting threshold is indicated based on a unit of millisecond.

20. The base station of claim 18,
wherein the DSR MAC CE with the multiple entries includes a first field indicating a shortest remaining time of buffered data associated with a corresponding reporting threshold at a time of a first symbol of a first physical uplink shared channel (PUSCH) transmission including the DSR MAC CE with the multiple entries.
